(19) United States
(12) Patent Application Publication
(10) Pub. No.: US 2024/0299790 A1
(43) Pub. Date: Sep. 12, 2024

(54) AUTOMATIC WATER EXTINGUISHER AND ASSOCIATED FIRE PROTECTION INSTALLATION

(71) Applicant: Groupe Save, Merignac (FR)

(72) Inventor: Philippe Kibler, Ternay (FR)

(21) Appl. No.: 18/279,563

(22) PCT Filed: Mar. 4, 2022
(86) PCT No.: PCT/FR2022/050392

§ 371 Date: Aug. 30, 2023

(30) Foreign Application Priority Data
Mar. 11, 2021 (FR) FR2102425
May 12, 2021 (FR) FR2105007

(51) Int. Cl. A62C 35/60; A62C 35/68; A62C 37/11

(52) U.S. Cl. CPC A62C 35/60; A62C 35/68; A62C 37/11

(57) ABSTRACT

The invention relates to an automatic water extinguisher intended to be mounted on an opening of a pipeline, said extinguisher comprising: a base having a through-hole, and a seal intended for sealing the connection between the opening and the through-hole. The base further comprises at least two anchoring points, and the extinguisher comprises at least one clamping collar comprising: an elongate element intended to partially surround the pipeline, said elongate element cooperating with the base at said anchoring points, ands means for adjusting the length of the at least one clamping collar so that the extinguisher is able to be mounted on pipelines of different diameters.

### TECHNOLOGICAL FIELD

The present invention relates to the field of fire protection installations. The invention is based, in particular, on an automatic water extinguisher including at least one clamping collar, the diameter of which is adapted to several pipeline diameters. The invention makes it possible, in particular to adapt in situ the extinguisher to several preexisting types of pipelines.

### BACKGROUND

Fires are one of the main causes of industrial accidents. Preventing fires is therefore a considerable challenge for companies and places receiving the public. Indeed, any incident linked to fire can cause considerable material and human damages. Companies are therefore bound to implement measures aiming to prevent the risk of fire, any breach being able to lead to legal proceedings and penalties.

Conventionally, fire protection installations are equipment configured to detect, indicate and secure a given zone. To do this, a fire protection installation generally comprises members for detecting the presence of a fire, inhibition members configured to stop fire, alert members configured to warm the presence of fire and a control station receiving information from detection members and triggering the inhibition and alert members in case of fire.

Among the different types of installations, fire protection installations using pressurised water conventionally comprise a pipeline network deployed within the zone to be protected. Pipelines comprise automatic water extinguishers, also known as “sprinklers”, which more often ensure both the inhibition function and the detection function. To do this, automatic water extinguishers comprise a base pierced with an opening, mounted on the pipeline. This opening is kept closed by a bulb or a fuse which is sensitive to temperature. In case of fire, the increase in temperature breaks the bulb or makes the fuse melt, which releases the pressurised water passage, which gushes out through the opening to spray the inflamed zone. In certain embodiments, the water flow hits a deflector, positioned directly facing the opening of the automatic water extinguisher. This deflector makes it possible to expand and to orient the water flow in the direction of the inflamed zone.

There are also variants of this installation, wherein the extinguishers do not ensure the detection function, but only the spraying function. In this case, pipelines do not contain continuously pressurised water, but the water is supplied to the extinguishers only when a fire has been detected moreover. In these embodiments, sprinklers do not comprise any bulb or fuse making it possible to block the passage of water.

To fix automatic water extinguishers on the pipelines, there is a first system consisting of welding a sleeve around an opening made in the pipeline. The automatic water extinguisher is then screwed on the sleeve. However, it is necessary to paint or galvanise the sleeve to give it the same colour as the rest of the pipeline, which can only be done after welding, and makes the process for manufacturing the installation more expensive.

To overcome these disadvantages, systems wherein the fixing of the sleeve onto the pipeline is no longer done by welding, but via a support collar have been developed.

According to a first example of an embodiment, the automatic water extinguisher is independent from the support collar. For example, document EP 0598151 describes a support collar comprising a connector making it possible to screw an automatic water extinguisher on the collar. To this end, the support collar comprises two parts. The first part, supporting the connector, is curved, to be adapted to the shape of the upper portion of a conduit. The second part is a part having a spring effect and making it possible to clip the support collar on the pipeline. In a variant, the second part can also be a curved, rigid part.

According to a second example of an embodiment, the automatic water extinguisher can be integral with the support collar. For example, document EP 3756733 describes a support collar comprising an upper part including the automatic water extinguisher and means for connecting with the lower part(s). The upper part is curved, in order to be adapted to the shape of the upper portion of a conduit. In a variant, the upper part can also be flat, such as illustrated in documents DE9106943 and GB8422476.

The lower part is a rigid, curved part, configured to be adapted to the shape of the lower and/or side portion of the conduit.

In any case, the curved shape of the first part and/or of the second part is such that it is impossible to adapt it for another pipeline diameter.

Indeed, there are no standards defining a standardised fire installation pipeline size on which the sprinklers are installed. The dimensions vary according to the needs and to the manufacturers. As an example, the pipelines found conventionally on the market have dimensions which vary in a range of standardised diameters of between 25 and 125 mm, also called “DN 25” or “DN 125”.

Thus, the systems proposed by the preceding documents require to know beforehand, the dimensions of the pipelines to be able to correctly choose the size of the support collars. This system therefore has an adaptability defect which can cause additional costs and installation delays in the case where the dimensions of the collars are not adapted to the dimensions of the pipelines.

The technical problem that the invention proposes to resolve, is therefore to develop an automatic water extinguisher which could be adapted to several existing pipeline diameters.

### SUMMARY OF THE DISCLOSURE

To resolve this problem, the invention proposes to develop an automatic water extinguisher comprising at least one clamping collar made of a flexible material making it possible to adapt it to the shape and to the size of the pipeline. The invention is therefore the result of a discovery according to which these flexible clamping collar can be substituted for the rigid collars of the prior art without losing quality of installations.

Indeed, the fire protection installations are subjected to very constraining standards which require that the installations are compliant at the time of their commissioning, but also that they preserve this compliance all throughout their life, in order to be effective at the time of a fire. These standards regulate in particular the pressures at which the components of the installation must resist.

Yet, a person skilled in the art would be naturally led to think that the flexible clamping collars of the invention have a too-high risk of wear and of deformation, in particular when they are subjected to pressures of around 10 bars necessary in the fire installations, for example of between 5 and 20 bars and preferably between 8 and 12 bars. A person skilled in the art would thus have avoided using these clamping collars for the field of sprinklers in order to limit the safety risks.

Thus, the invention relates to an automatic water extinguisher intended to be mounted on an opening of a pipeline, said pipeline forming part of an installation configured to contain water pressurised from 5 to 20 bars, said extinguisher comprising:
a one-piece base having a through-hole, and
a seal intended to seal the connection between the opening of said pipeline and the through-hole of said base.

Such an extinguisher is characterised in that:
the base further comprises at least two anchoring points, and
the extinguisher comprises at least one clamping collar comprising:
an elongate element intended to partially surround the pipeline, said elongate element cooperating with the base at said anchoring points, and
adjustment means independent of the base, making it possible to adapt the length of the at least one clamping collar so that the extinguisher is able to be mounted on pipelines of different diameters.

In other words, the adjustment means make it possible to adapt the length of the clamping collar with respect to the diameter of the pipeline. For example, the collar can have a sufficient length to be adapted to diameters of between 25 and 50 mm.

To obtain this adaptation capacity, the adjustment means can be presented in the form of a loop, cooperating with notches made in the elongate element.

The adjustment means are further independent of the base, in order to be positioned in a distant zone of the base and thus be able to best resist the pressure constraints being exerted on the opening of the pipeline. Indeed, the more the adjustment means are distant from the base, the better the clamping collar resists extension, deformation and breaking.

Preferably, the adjustment means are installed diametrically opposite the opening of the pipeline, to best compensate for the pressure force being exerted on the base, from the opening of the pipeline. The tension being exerted around the pipeline, it is thus better distributed.

According to the invention, the base is one-piece, i.e. that the base is a part formed of one single holding, opposed to a part coming from the assembly of several constitutive elements, such as described, for example, in document WO2018/014066. Given the high pressures exerted, the use of a one-piece base makes it possible to guarantee a long-lasting resistance for a guarantee duration of operation, for example for 5 or 10 years of operation.

The association of the seal, the adjustment means and the elongate element cooperating with the base, makes it possible to guarantee the sealing of the connection between the pipeline and the automatic extinguisher, as well as the adaptability of the clamping collar to different pipeline diameters. Indeed, the elongate element makes it possible to press the base against the pipeline, while the seal, interposed between the base and the pipeline is compressed. Under the traction of the elongate element on the base, the seal is deformed to guarantee the sealing of the base around the through-hole of the pipeline and to follow the curvature of the pipeline. Thus, the seal under the pressure of the base makes it possible to absorb the differences of curvatures between the pipeline and the base. Furthermore, the adjustment means make it possible to secure the elongate element in a position, wherein the seal is compressed, so that the compression capacity of the seal also fills the lack of progressiveness of the fixing positions of the clamping means.

It ensues that the traction exerted by the elongate element on the base, the modularity of the adjustment means and the deformation capacity of the seal make it possible to adapt the support device to pipelines of variable diameters.

Moreover, the adjustment means and the elongate element are durable over time, i.e. that they do not deform and do not malfunction over time. The connection therefore remains durably sealed.

Furthermore, the association of the adjustment means and of the seal also makes it possible to adapt the length of the clamping collar to very low variations of the diameter of the pipeline, due to manufacturing tolerances. Indeed, among the pipelines of a given diameter, for example for a diameter of 25 mm, the tolerance of the manufacturer can provide a margin of +/−1 mm within which the diameter of the pipeline can vary. Preferably, the notches of the adjustment means have a sufficiently reduced pitch to enable the adaptation to the tolerance of the manufacturer.

The automatic water extinguisher can be positioned with any orientation with respect to the pipeline, as long as it is fixed to an opening of the pipeline. As an example, the automatic water extinguisher can be positioned above the pipeline, below or on the side.

The length of the clamping collars corresponds to the useful portion of the collars, which is intended to be positioned against the walls of the pipeline. Indeed, a clamping collar can have a fixed total length, but during the adjustment, only one portion of the collar can be used effectively to hold the automatic water extinguisher against the pipeline. The useless portion can optionally be cut to not impede the extinguishing generated by the automatic extinguisher.

Advantageously, such an automatic water extinguisher makes it possible to make the installation more compact. Indeed, the invention makes it possible to do without the presence of a sleeve for receiving the automatic extinguisher. This configuration therefore makes it possible to reduce the height of the automatic water extinguisher. This can therefore be more easily inserted in reduced spaces, such as storage racks, or spaces under a low ceiling, for example.

Furthermore, clamping collars being able to adapt to several pipeline diameters make it possible to limit the number of different collar size references, which limits the production costs. Moreover, the adjustment of the clamping collars can be done substantially continuously, contrary to the support collars of the prior art, which have a shape adapted to one single pipeline diameter.

In addition, the clamping collars of the invention make it possible to adapt the automatic water extinguisher in situ, without having to provide the number and the size of the collars beforehand. This enables significant time savings and a significant decrease of the cost price.

In an embodiment, the extinguisher comprises one single clamping collar and only two anchoring points disposed either side of the base.

Indeed, a person skilled in the art thinking that the flexible clamping collars of the invention have a too-high risk of wear and of deformation, would be led to multiply the number of clamping collars to reinforce the structure of the clamping collar. Yet, the invention makes it possible, against all expectations, to only use one single clamping collar without increasing the risks of leakages, for example.

In the sense of the invention, the “anchoring points” correspond to the receiving elements of the base, making it possible to fix the clamping collar when the clamping collar is enclosed around the pipeline. These anchoring points can correspond to openings or excrescences, such as lugs.

According to an embodiment, the anchoring points are through openings oriented in a direction parallel to the main direction of the pipeline, the elongate element being mounted on the base by inserting at least one end of the elongate element in the through openings and by forming a loop around the borders of said base.

According to the invention, the main direction of the pipeline corresponds to the direction parallel to the length of the pipeline.

The mounting of the clamping collar on the base is thus facilitated, as the adjustment method is easily reproducible and requires few tools. As an example, it suffices to pass through the two openings from bottom to top, so that the elongate element surrounds the pipeline. The ends of the elongate element are then pulled from the top of the base and folded above the ends of the base to clamp the clamping collar around the pipeline. The ends of the elongate element are then returned together and fixed by the adjustment means. The installation of the automatic water extinguishers on the pipelines is thus mainly made quicker.

In practice, the through openings can correspond to slots made in the base. In a variant, the through openings can correspond to the space formed between the base and an axis mounted on the base.

Preferably, the openings are made symmetrically with respect to a central axis of the base, thus making it possible to reduce the risks of incorrect positioning of the automatic water extinguisher against the opening of the pipeline.

According to another embodiment, the two ends of the elongate element are configured to cooperate with the anchoring points disposed either side of the base, so that the elongate element partially surrounds the pipeline after action on the adjustment means.

In practice, each anchoring point comprises a housing delimited by two lugs, separated by a slot sized to enable the passage of the elongate element, the housing being intended to receive an axis fixed to an end of the elongate element, the lugs being intended to enable the insertion of the axes in the housings before action on the adjustment means and to block the extraction of said axes after action on the adjustment means.

The mounting of the clamping collar on the base is thus facilitated as the adjustment method is easily reproducible and requires few tools. It suffices that the elongate element surrounds the pipeline and that its ends, provided with an axis, are blocked in the housings of the base. The clamping collar is then adapted to the diameter of the pipeline via the adjustment means. The installation of the automatic water extinguishers on the pipelines is thus mainly made quicker.

In a variant, each anchoring point comprises a lug intended to cooperate with a hole made at the ends of the elongate element.

The mounting of the clamping collar on the base is done by mounting the elongate element around the pipeline so that its ends, provided with a hole, are blocked on the lugs of the base. The clamping collar is then adapted to the diameter of the pipeline via the adjustment means.

The elongate element can take different forms. In a first form, the elongate element is a strip, i.e. of form similar to a band. In a variant, the elongate element is a cable, thinner but however just as resistant. Indeed, the invention makes it possible to use elongate elements, the width of which is reduced without compromising the safety of the installations.

In practice, the elongate element is formed in a metal material, as surprisingly, the invention makes it possible to use different materials to produce the elongate element without compromising the safety of the installations.

Advantageously, the means for adjusting the length of the at least one clamping collar comprise markers making it possible to compress the seal at a predetermined rate.

This embodiment makes it possible to facilitate the installation of the clamping collar and to remove risks of errors. The technician can indeed rely on visual markers during the installation, indicating them how far to clamp the clamping collar so that the seal is optimally compressed to not create leakages according to the diameter and to the service pressure. In a variant, these adjustment markers can also be replaced by or associated with an appliance for measuring the adjustment tension of the clamping collar.

Furthermore, in a preferable embodiment, the adjustment means are integral with an end of the elongate element.

Indeed, this embodiment makes it possible to achieve the clamping of the automatic extinguisher on the pipeline by performing a simple movement of pulling the free end of the elongate element.

A clamping collar having the preceding features makes it possible to advantageously simplify and reduce the time necessary for the mounting of the automatic water extinguisher on the pipeline.

However, the system for blocking the elongate element could be different, without this damaging the correct operation of the invention.

In certain embodiments of the invention, the automatic water extinguisher further comprises an element for blocking said through-hole sensitive to temperature and configured to release the through-hole when the temperature exceeds a threshold value so as to extract a water flow from the pipeline.

Advantageously, the automatic water extinguisher also comprises a deflector fixed above said base and intended to spray the water flow coming from the pipeline.

These elements form the head of the automatic water extinguisher. The invention covers the embodiments wherein the stirrups and the base form a monolithic block, on which a deflector and a blocking element will be mounted. Alternatively, the invention also covers the embodiments, wherein the head, formed by the stirrups, the deflector and the blocking element, is independent of the base.

In other words, according to a first embodiment, the base and the head, comprising the deflector, the stirrups and/or the blocking element form a monolithic block.

According to a second embodiment, the base and the head, comprising the deflector, the stirrups and/or the blocking element are independent, the head being mounted on the base by screwing, by interlocking in a grooved connector or by any other cooperation means.

According to another aspect, the invention relates to a fire protection installation including:
at least one pipeline having at least one opening, and
at least one automatic water extinguisher such as described above.

Preferably, the pipeline is a pipeline, painted or pre-painted on its internal and external faces, i.e. that the pipeline comprises a painting covering its internal and external faces. The painting makes it possible to protect the pipeline from degradations, in particular those caused by rust.

The painting applied must make it possible to make piercings and cuttings without flaking, thus reducing considerably the manufacturing time in the workshop. Indeed, the painting phase after manufacturing usually done in the known methods is removed.

Preferably, the painting of the pipeline comprises an epoxide polymer binder, particularly resistant during piercing and cutting.

### BRIEF DESCRIPTION OF THE FIGURES

The way in which to achieve the invention, as well as the advantages which arise from this, will emerge from the description of the embodiments below, in support of the accompanying figures, wherein:

FIG. 1 is a perspective view of a pipeline on which four automatic water extinguishers according to four different embodiments are fixed,

FIG. 2 is a perspective view of a pipeline on which four automatic water extinguishers according to another four different embodiments are fixed,

FIG. 3 is a front view of an automatic water extinguisher mounted on a pipeline according to a first embodiment of FIG. 1,

FIG. 4 is a side view of an automatic water extinguisher mounted on a pipeline according to the first embodiment of FIG. 1,

FIG. 5 is a top view of an automatic water extinguisher mounted on a pipeline according to the first embodiment of FIG. 1,

FIG. 6 is a front view of an automatic water extinguisher mounted on a pipeline according to a second embodiment of FIG. 1,

FIG. 7 is a side view of an automatic water extinguisher mounted on a pipeline according to the second embodiment of FIG. 1,

FIG. 8 is a top view of an automatic water extinguisher mounted on a pipeline according to the second embodiment of FIG. 1,

FIG. 9 is a front view of an automatic water extinguisher mounted on a pipeline according to a third embodiment of FIG. 1,

FIG. 10 is a side view of an automatic water extinguisher mounted on a pipeline according to the third embodiment of FIG. 1,

FIG. 11 is a top view of an automatic water extinguisher mounted on a pipeline according to the third embodiment of FIG. 1,

FIG. 12 is a front view of an automatic water extinguisher mounted on a pipeline according to a fourth embodiment of FIG. 1,

FIG. 13 is a side view of an automatic water extinguisher mounted on a pipeline according to the fourth embodiment of FIG. 1,

FIG. 14 is a top view of an automatic water extinguisher mounted on a pipeline according to the fourth embodiment of FIG. 1,

FIG. 15 is a front view of an automatic water extinguisher mounted on a pipeline according to a fifth embodiment of FIG. 2,

FIG. 16 is a side view of an automatic water extinguisher mounted on a pipeline according to the fifth embodiment of FIG. 2,

FIG. 17 is a top view of an automatic water extinguisher mounted on a pipeline according to the fifth embodiment of FIG. 2,

FIG. 18 is a front view of an automatic water extinguisher mounted on a pipeline according to a sixth embodiment of FIG. 2,

FIG. 19 is a side view of an automatic water extinguisher mounted on a pipeline according to the sixth embodiment of FIG. 2,

FIG. 20 is a top view of an automatic water extinguisher mounted on a pipeline according to the sixth embodiment of FIG. 2,

FIG. 21 is a front view of an automatic water extinguisher mounted on a pipeline according to a seventh embodiment of FIG. 2,

FIG. 22 is a side view of an automatic water extinguisher mounted on a pipeline according to the seventh embodiment of FIG. 2,

FIG. 23 is a top view of an automatic water extinguisher mounted on a pipeline according to the seventh embodiment of FIG. 2,

FIG. 24 is a front view of an automatic water extinguisher mounted on a pipeline according to an eighth embodiment of FIG. 2,

FIG. 25 is a side view of an automatic water extinguisher mounted on a pipeline according to the eighth embodiment of FIG. 2,

FIG. 26 is a top view of an automatic water extinguisher mounted on a pipeline according to the eighth embodiment of FIG. 2,

FIG. 27 is a perspective view of the base of an automatic water extinguisher mounted on a pipeline and of the clamping collar according to a ninth embodiment of the invention,

FIG. 28 is a perspective view of the adjustment means of the clamping collar of FIG. 27,

FIG. 29 is a partial cross-sectional view of the means for adjusting the clamping collar of FIG. 27,

FIG. 30a is a cross-sectional view of a first step of installing an automatic water extinguisher according to a tenth embodiment of the invention,

FIG. 30b is a cross-sectional view of a second step of installing an automatic water extinguisher according to a tenth embodiment of the invention,

FIG. 30c is a cross-sectional view of a third step of installing an automatic water extinguisher according to a tenth embodiment of the invention,

FIG. 30d is a cross-sectional view of a fourth step of installing an automatic water extinguisher according to a tenth embodiment of the invention,

FIG. 31 is a high-angle perspective view of the base of an automatic water extinguisher according to an eleventh embodiment of the invention,

FIG. 32 is a front view of the base of the automatic water extinguisher of FIG. 31, and

FIG. 33 is a low-angle perspective view of the base of the automatic water extinguisher of FIG. 31.

### DETAILED DESCRIPTION

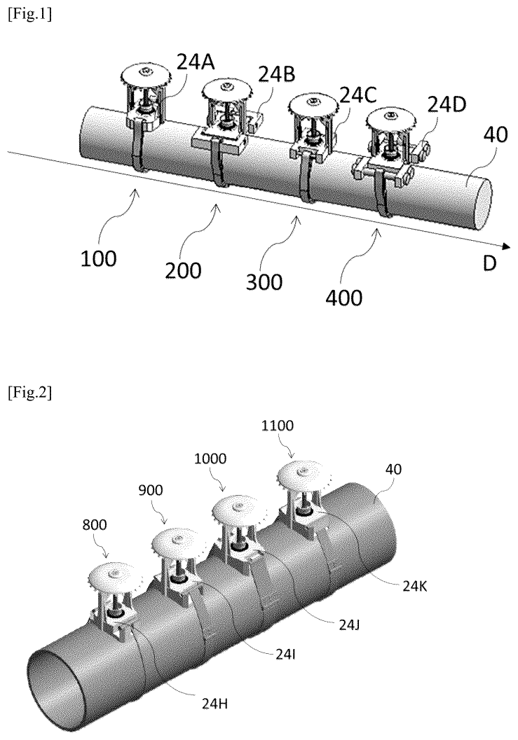

Such as illustrated in FIGS. 1 and 2, automatic water extinguishers 100, 200, 300, 400, 800, 900, 1000, 1100 are mounted on a fire protection installation comprising at least one pipeline 40.

The pipeline 40 is configured to support pressures of around ten bars, for example of between 5 and 20 bars and preferably between 8 and 12 bars. To do this, the pipeline 40 is preferably made of a material having good deformation-resistant properties, typically made of steel, stainless steel, galvanised steel, copper or chlorinated polyvinyl chloride.

Furthermore, the diameter of the pipeline 40 can vary, typically between 25 and 125 mm, also called “DN 25” or “DN 125”, according to the needs linked to the zone to be protected, dimensions of the installation and of the positioning of the automatic extinguisher with respect to the water source.

As an example, the fire protection installation can be formed of a central pipeline skeleton 40 of a greater dimension and of ramifications formed by pipelines of a smaller diameter.

In order to integrate the automatic water extinguishers 100, 200, 300, 400, 800, 900, 1000, 1100 of the invention, one or more openings 42 are made in the pipelines 40. The openings 42 are, for example, circular in top view, of a diameter of between 10 and 25 mm, also called “DN 10”, or “DN 25”. The diameter of the opening 42 is sized according to the sprinkler head which will be chosen for the extinguishing of the zone to be protected. Furthermore, it has also been observed that the invention can also be implemented for pipelines of DN 32 to DN 40.

The distance separating two openings 42 is adjusted generally between 2 and 4.6 m. Likewise, an opening 42 must be distant by at least 1 m from a wall of the zone to be protected. It has been recently observed that the distance separating two openings 42 can be 0.9 m.

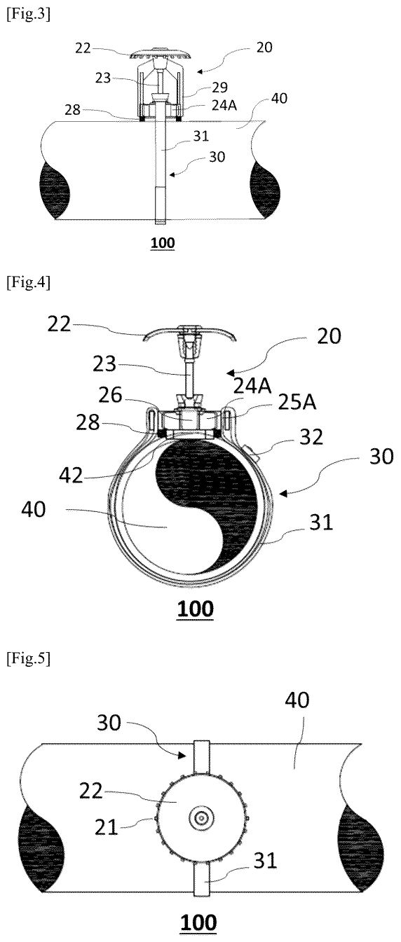

FIGS. 1 and 2 illustrate several embodiments of automatic water extinguishers 100, 200, 300, 400, 800, 900, 1000, 1100 according to the invention. All the embodiments however have common elements. As an example, in reference to FIGS. 3 to 5, the automatic water extinguishers 100, 200, 300, 400, 800, 900, 1000, 1100 are formed of a one-piece base 24A-24D, 2AH-24K having a flat, substantially parallelepiped shape of a thickness of between 0.5 and 1.5 cm. In a variant, the lower face of the base 24E, 24G can have a slight curvature, such as illustrated in FIGS. 27 and 31-33. The curvature of the lower face is chosen to be adapted to the curvature of the pipeline 40 of a greater diameter on which the automatic water extinguisher 500, 700 can be adapted. More recently, bases 24E, 24G having a thickness of 3 mm have been observed.

The base 24A-24D, 2AH-24K can be directly obtained by a moulding method, a method by subtracting material such as machining or laser cutting, or also by an additive method, such as 3D printing.

The base 24A-24K further has, for example, a through-opening 26 of a diameter of between 2 and 10 mm. The diameter can be greater, without changing the invention, typically of between 10 and 500 mm.

Advantageously, a seal 28 is positioned facing the lower face of the base 24A-24K, typically between the base 24A-24K and the pipeline 40, so as to surround the openings 26 and 42 respectively of the base 24A-24 K and of the pipeline 40. As an example, the seal 28 is a rubber O-ring of a thickness of between 0.2 and 0.7 cm. In a variant, for the pipelines of a greater diameter, the seal can comprise lips and have a thickness of between 0.5 and 3 cm.

The opening 26 of the base 24A-24 K is preferably blocked by a heat-sensitive blocking element 23, typically a glass bulb or a fuse configured to degrade when the temperature in the proximity of the automatic water extinguishers 100, 200, 300, 400, 500, 600, 700, 800, 900, 1000, 1100 reaches a triggering threshold value, typically of between 57 and 343° C.

There are several temperature standards for degrading the bulbs and/or fuses. These standards are, in particular, recognisable to the colour of the liquid contained in the bulb. As an example, the red colour corresponds to a triggering temperature of 68° C.

Advantageously, a deflector 22 is positioned facing the opening 26 of the base 24A-24D, 24H-24K. The deflector 22 has a shape similar to an umbrella or a parasol, i.e. a circular surface, preferably curved, the concave part of which is positioned facing the opening 26 so as to intercept a water flow coming from the opening 26 and to redirect it to the inflamed zone. In a variant, the deflector 22 can have any other shape enabling an effective dispersion of the water flow.

Advantageously, the perimeter of the deflector is provided with fins 21. The deflector 22 is held by side stirrups 29, advantageously two of them. The assembly is, for example, made of brass, bronze, aluminium, stainless steel, titanium or copper. A screw is, for example, fixed at the junction between the stirrups 29 and the deflector. The screw makes it possible to both hold the deflector and press on the blocking element 23.

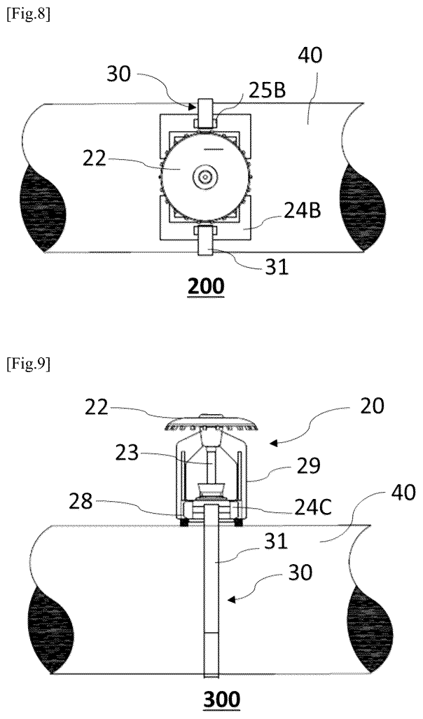

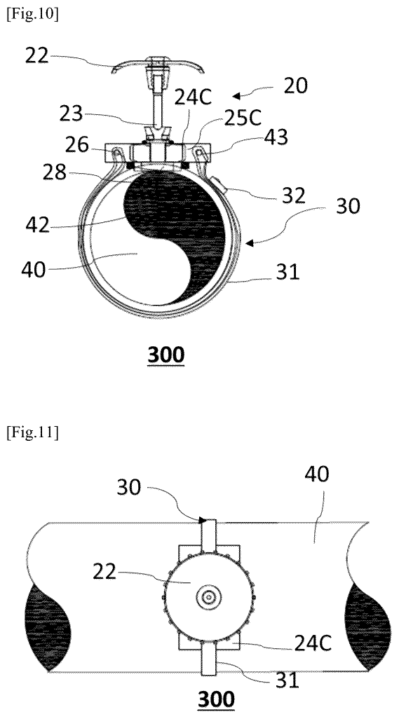

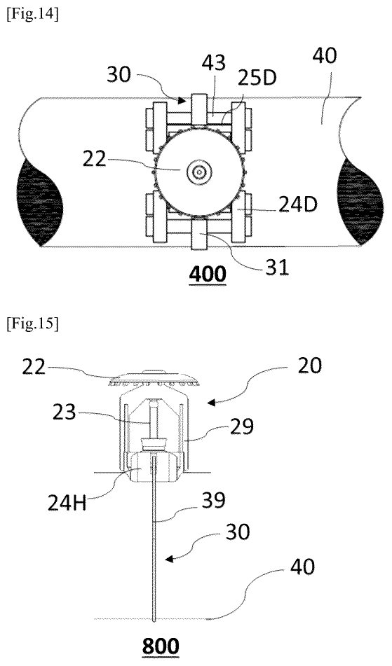

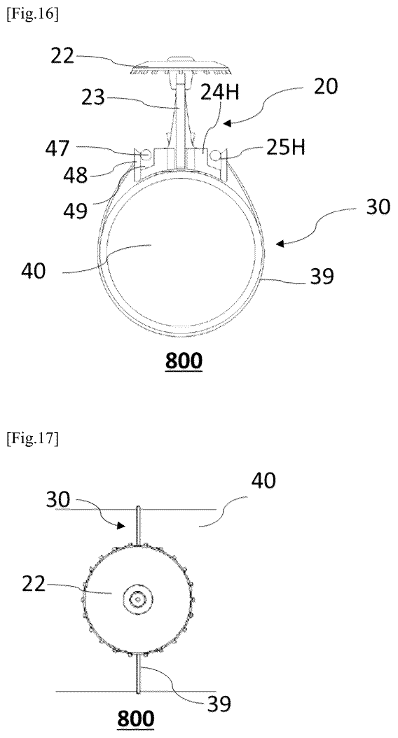

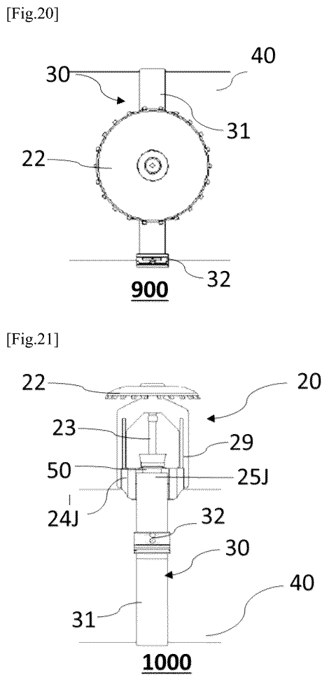

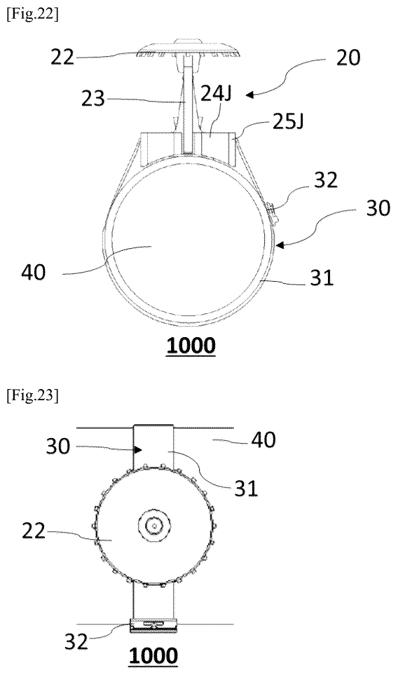

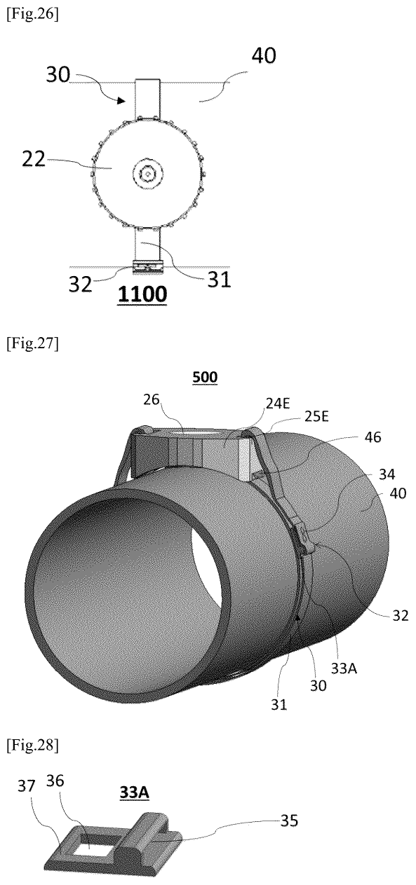

According to the embodiments illustrated in FIGS. 1 to 26, the assembly formed by the deflector 22, the stirrups 29 and the blocking element 23, also called “head” 20, is integral with the base 24A-24D, 24H-24K.

In other embodiments, illustrated for example in FIGS. 27 and 31 to 33, the head 20, not represented, can be independent of the base 24E, 24G, i.e. that the head 20 can be mounted on the base 24E, 24G by aligning the through-opening of the head 20 with the through-opening 26 of the base 24E, 24G. For example, the head 20 can have a male portion having a thread or a groove and cooperating with a second thread or a groove made in the walls of the through-opening 26 of the base 24E, 24G. The head 20 can thus be screwed or fixed by way of a grooved connector on the base 24E, 24G.

The clamping collar(s) 30 make(s) it possible to fix and hold the head 20 on the pipeline 40. The clamping collars 30 comprise an elongate element, like for example a strip of a width of between 0.5 and 2 cm, or also a cable of diameter of between 0.2 and 1 cm. In a variant, the elongate element can be a “serflex”-type clamping element, made of a metal material. The clamping collars 30 also comprise adjustment means 32 of the length and the clamping of a clamping collar 30. The base 24A-24K can be provided with one or more clamping collars 30 according to the needs of the installation and of the diameter of the pipeline 40.

The adjustment means 32 are independent of the base 24A-24K.

According to a first example, the adjustment means 32 can also be independent of the elongate element of the clamping collar 30. They can be constituted of one or more mounted parts which can be fixed or interlocked on the elongate element in order to hold it in place.

Such as illustrated in FIGS. 27 to 29, the clamping collar 30 can be presented in the form of a metal strip 31 and the adjustment means can include a loop 33A, independent of the strip 31, comprising a housing 35 wherein the ends of the strip 31 are inserted. Self-tapping screws 34 make it possible to pierce the different strip 31 thicknesses. Advantageously, the loop 33A has an opening 36 making it possible to receive the lower portion of the body of the screw 34.

Thus, the elongate element can be directly adapted to the diameter and to the tolerance of a pipeline 40 by creating the opening necessary so that the seal 28 is compressed with an optimal compression rate and that the connection between the pipeline and the automatic extinguisher is made as sealed as possible. The adjustment is done “bespoke”, and the adjustment options are almost continuous.

In a variant, in an embodiment not represented in the figures, the elongate element can be a metal strip comprising openings made regularly and closely along the elongate element. So that the elongate element can be directly adapted to the diameter and to the tolerance of a pipeline, the pitch between the openings is preferably less than or equal to the tolerance of the manufacturer. Typically, if the pipeline has a diameter of 25 mm and that the tolerance is +/−1 mm, the pitch between the openings is less than or equal to 1 mm. Thus, the seal can be compressed with an optimal compression rate, and the connection between the pipeline and the automatic extinguisher is made as sealed as possible.

In order to fix the base 24E on the pipeline 40, this is positioned on the opening 42 of the pipeline 40, so that the stirrups of the head are aligned with the length of the pipeline 40 so that water gushes out in a direction perpendicular to the main direction D of the pipeline 40. The two ends of the strip 31 are inserted, in a bottom to top movement, through the anchoring points, materialised by side openings 25E so that the strip 31 surrounds the pipeline 40. The ends of the strip 31 are then pulled from the top of the base 24E and folded above the ends of the base 24E to clamp the clamping collar 30 around the pipeline 40. The ends of the strip 31 are then returned together, thus forming a loop around each edge of the base 24E. The ends of the strip 31 are then fixed together by the adjustment means 32.

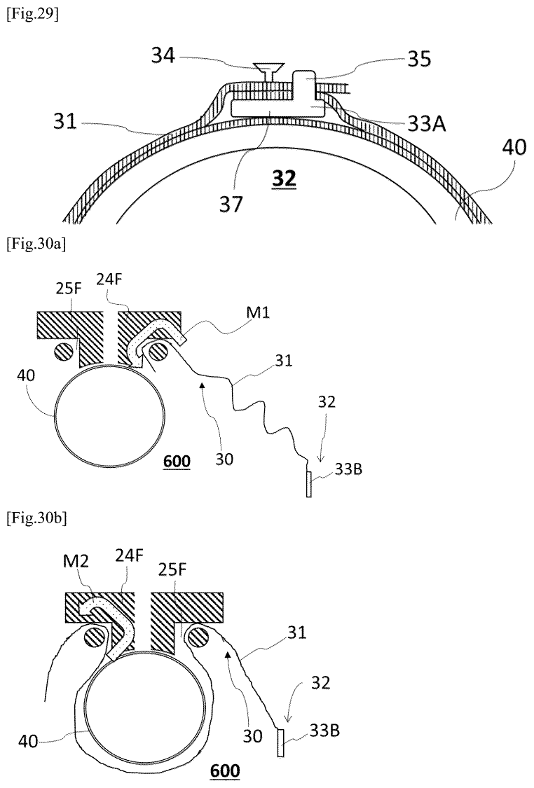

Thus, such as illustrated in FIG. 29, the loop 33A is positioned on a first strip 31 thickness. The ends of the strip 31 are then folded and inserted in the housing 35 of the loop 33A, then clamped so as to effectively hold the base 24E on the pipeline 40. To do this, the ends of the strip 31 go past each side of the housing 35 over a length of at least 1 cm. The ends of the strip 31 are thus superposed at the body 37 of the loop 33A. The screw 34 is finally inserted at this superposition and pierces the two thicknesses formed by the ends of the strip 31.

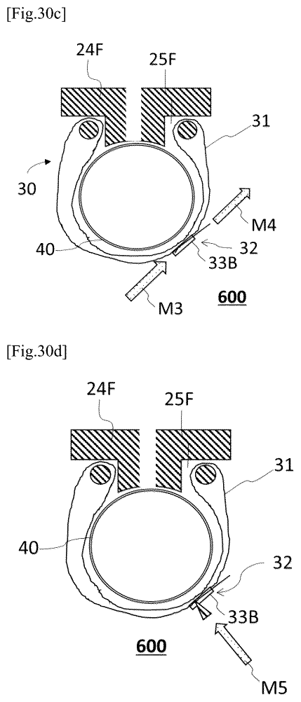

In a variant, such as illustrated in FIGS. 30a to 30d, the adjustment means 32 can be integral with an end of the strip. Thus, the clamping collar 30 can be presented in the form of a metal strip 31 and the adjustment means can include a loop 33B comprising a housing 35, fixed to the end of the strip 31.

The housing 35 can take the form of a tube of parallelepiped cross-section, intended to enable the passage of a part of the metal strip 31. Furthermore, the fixing means, such as a self-tapping screw 34, can be placed on the housing 35, perpendicularly to the length of the tube and in the movement direction of the strip 31 in the tube, so as to restrain the movements of the strip 31 when it is compressed around the pipeline 40 and inserted in the tube.

In an alternative embodiment not represented, the fixing means include a ball contained in the tube and intended to block the movements of the elongate element. To do this, the tube has a variable cross-section. Typically, the cross-section of the tube is narrowed from the dimensions greater than the diameter of the ball up to dimensions substantially equal to the diameter of the ball. Thus, during the sliding of the elongate element in the tube, the ball is driven in a direction opposite the insertion direction of the elongate element, towards the part of the tube of reduced dimensions, where it gets blocked. The ball thus also blocks the elongate element.

In the embodiment of FIGS. 30a-30d, the spaces 25F of the base 24F are used to create fixing points of the strip 31. To do this, such as illustrated in FIG. 30a, the end of the strip 31 not provided with the loop 33B is inserted in a first movement M1 to surround a first fixing point of the base 24F. This movement M1 is performed by inserting the strip 31 in the space 25F from the upper face of the base 24F up to the lower face of the base 24F until the strip 31 arrives along the pipeline 40.

The strip 31 is thus moved around the pipeline 40 up to the second fixing point of the base 24F. Such as illustrated in FIG. 30b, the strip 31 is thus introduced in the space 25F according to the movement M2 to surround the second fixing point of the base 24F. This movement M2 is performed by inserting the strip 31 in the space 25F from the lower face of the base 24F up to the upper face of the base 24F until the strip 31 arrives along the pipeline 40.

The strip 31 is thus introduced in the loop 33B according to the movement M3, illustrated in FIG. 30c. The clamping collar 30 is then compressed around the pipeline 40 by pulling on the end of the strip 33 after its passage into the housing of the loop 33B, according to the movement M4.

In certain embodiments, when the sought compression tension of the strip 31 is obtained, means for fixing the strip 31 in the housing can be inserted in the loop 33C by means of an action in a direction M5, perpendicular to the length of the housing 35, such as illustrated in FIG. 30d. Subsequently, the remaining end of the strip 31 going past the loop 33C can optionally be split.

Furthermore, the strip can also have notches or grooves making it possible to receive or to block the adjustment means 32.

Advantageously, the clamping collar 30 also has markers making it possible to adapt the clamping to the pressure and to the diameter in the pipeline 40.

There are several embodiments making it possible to attach the clamping collar 30 to the base 24A-24K.

Such as illustrated in FIGS. 3 to 5, in a first embodiment, the base 24A has a parallelepiped shape with bevels at the corners. The base 24A has a length of between 2 and 10 cm and a width of between 2 and 5 cm. The length of the base 24A is intended to be positioned in a direction perpendicular to the main direction D of the pipeline 40. The base 24A has in its ends, two side grooves 25A made in the thickness of the base 24A, of substantially parallelpiped shape and intended to enable the passage of the strip 31 of the clamping collar 30.

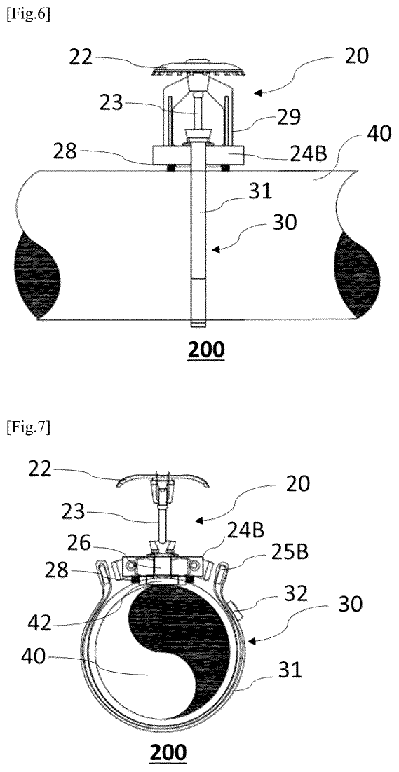

Such as illustrated in FIGS. 6 to 8, in a second embodiment, the base 24B has a parallelepiped shape of length of between 4 and 10 cm and of width of between 4 and 10 cm. The length of the base is intended to be oriented in a direction perpendicular to the main direction D of the pipeline 40. The base 24B has a central, parallelepiped-shaped groove, as well as two side recesses making it possible to receive and to fix the stirrups 29. In addition, the base 24B comprises in its ends, two grooves 25B, made in the thickness of the base 24B, substantially parallelepiped-shaped, and intended to enable the passage of the strip 31 of the clamping collar 30.

Such as illustrated in FIGS. 9 to 11, in a third embodiment, the base 24C has a parallelepiped shape of length of between 2 and 10 cm and of width of between 2 and 5 cm. The length of the base is intended to be oriented in a direction perpendicular to the main direction D of the pipeline 40. The base 24C has anchoring points formed by two recesses making it possible to create openings 25C. The end of the recesses comprises two axes 43. Thus, the strip 31 of the clamping collar 30 passes through the openings 25C and forms a loop around the axes 43.

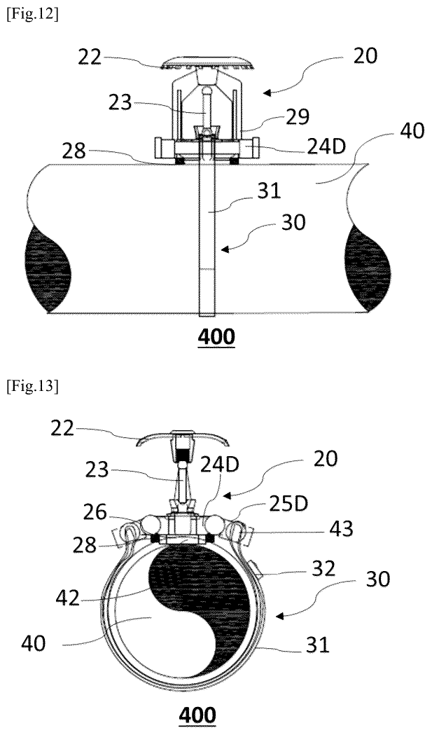

Such as illustrated in FIGS. 12 to 14, in a fourth embodiment, the base 24D has a parallelepiped shape of length of between 2 and 8 cm and of width of between 2 and 5 cm. The length of the base 24D is intended to be oriented in a direction perpendicular to the main direction D of the pipeline 40.

The base 24D further has means for fixing two axes 43 mounted either side of the base 24D. The axes 43 are anchoring points of the clamping collar 30, positioned so as to leave a space 25D free between the edges of the base 24D and the axes 43. This space 25D is intended to enable the passage of the strip 31 of the clamping collar 30, this thus being able to form a loop around the axes 43.

Such as illustrated in FIGS. 15 to 17, in a fifth embodiment, the base 24H comprises two anchoring points 25H, either side of the base 24H. Each anchoring point 25H comprises a housing 49 having a depth of between 0.3 and 1 cm and sized to receive an axis 47 of a length of between 0.5 and 4 cm and of a diameter of between 0.1 and 1 cm. In this fifth embodiment, the housing 49 extends over the whole width of the base 24H. The housing 49 is bordered by two parallelepiped-shaped lugs 48. Preferably, the upper portion has a bevelled or rounded shape to make it possible to guide the movement of the axis 47 towards the housing 49 during the installation of the two axes 47 in the anchoring points 25H. The two lugs 48 are separated by a slot, sized to enable the passage of the cable 39, and to retain the axis 47 during the clamping of the cable 39 around the pipeline 40. Thus, when the cable 39 is taut around the pipeline 40, the axis 47 is fixed in the housing 49, retained by the lugs 48.

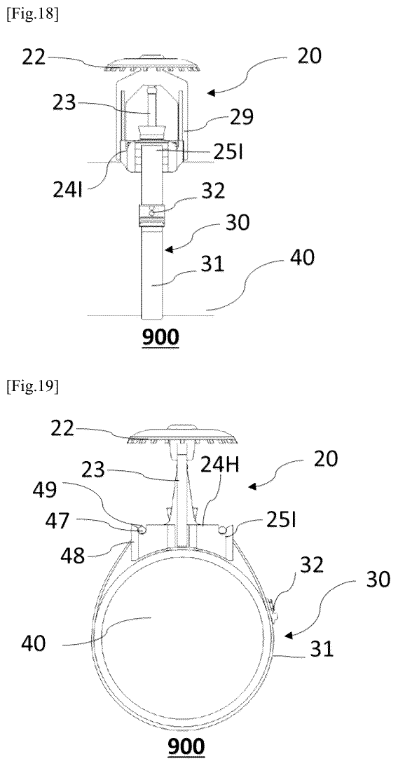

Such as illustrated in FIGS. 18 to 20, in the sixth embodiment, the housing 49 of the anchoring points 25I can have a lower depth without leading to the extraction of the axis 47. The width of the slot can further be adapted to the width of the elongate element 31. In the sixth embodiment, the slot is sized to enable the passage of a strip 31.

Such as illustrated in FIGS. 21 to 23, in a seventh embodiment, the base 24J has anchoring points 25J comprising a lug 50 intended to cooperate with a hole made at the ends of the elongate element 31. In order to mount the elongate element on the base 24J, the holes of the elongate element 31 are inserted on the lugs 50 so as to also surround the pipeline 50, then the clamping collar 30 is adapted to the diameter of the pipeline via the adjustment means 32.

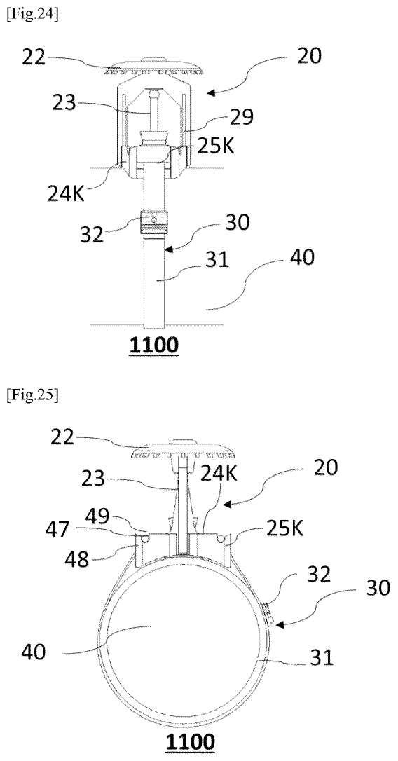

Such as illustrated in FIGS. 24 to 26, in an eighth embodiment, the base 24K has a housing 49 bordered by two lugs 48 separated by a slot, sized to enable the passage of the width of the elongate element 31. The slot is covered by a plate connecting the two lugs 48, thus creating a space of a thickness of between 0.05 and 0.2 cm, not enabling the passage of the axis 47, but only that of the elongate element 31. Thus, in order to insert the elongate element 31, the axis 49 must first be removed, then the end portion of the elongate element 31 is inserted in the slot covered by the plate. The axis 47 is then fixed to the end of the elongate element 31, for example by sliding it into a loop created at the end of the elongate element 31. Finally, the axis 47 is inserted in the housing 49. The axis 47 cannot thus be extracted from the housing 49, as it is blocked by the presence of the plate.

Such as illustrated in FIG. 27, in a ninth embodiment of the invention, the base 24E comprises grooves 25E made in the thickness of the base 24E. A bore 46 is also made on the lower portion of the grooves 25E enabling the groove to open outwards. This bore 46 makes it possible for the strip 31 to best adapt to the shape of the pipeline 40.

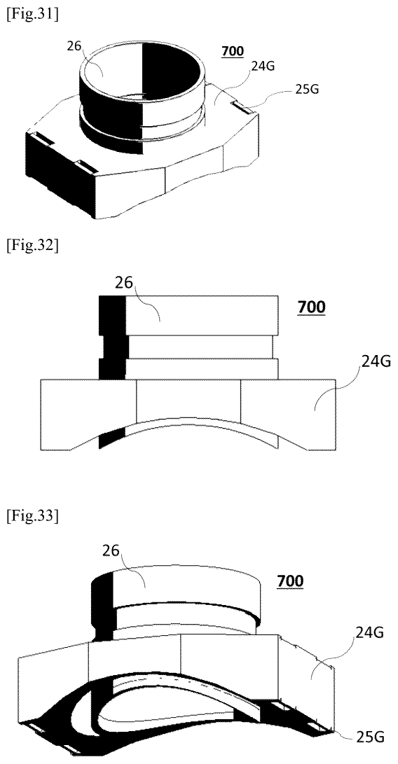

Such as illustrated in FIGS. 31 to 33, in an eleventh embodiment, the base 24G can be mounted on the pipeline 40 before the extinguisher is fixed on the base 24G. In this embodiment, the base 24G has a substantially hexagonal shape of length of between 2 and 8 cm and of width of between 2 and 5 cm. The length of the base 24G is intended to be oriented in a direction perpendicular to the main direction D of the pipeline 40.

The base 24G further has two pairs of side grooves 25G made either side of the base 24G in the thickness of the base 24G, substantially parallelepiped-shaped and intended to enable the passage of two clamping collars 30. Preferably, the grooves are spaced apart from 1 to 3 cm. This type of base 24G is particularly indicated in the case where the extinguisher has a grooved head 20 mounted on the base 24G, for example for pipelines 40 with a large diameter, typically greater than DN50.

The mounting of the two clamping collars 30 is done in the same way as described in FIGS. 17a-17d, the clamping collars 30 being able to be mounted simultaneously after one another.

To conclude, the invention makes it possible to develop an automatic water extinguisher being able to adapt to all the existing pipeline diameters.

1. An automatic water extinguisher configured to be mounted on an opening of a pipeline, said pipeline forming part of an installation configured to contain water pressurised between 5 and 20 bars, said extinguisher comprising:
a one-piece base having a through-hole, and
a seal configured to seal the connection between the opening of said pipeline and the through-hole of said base, wherein:
the base further comprises at least two anchoring points, and
the extinguisher comprises at least one clamping collar comprising:
an elongate element configured to partially surround the pipeline, said elongate element cooperating with the base at said anchoring points, and
adjustment means, independent of the base, making it possible to adapt the length of the at least one clamping collar so that the extinguisher is able to be mounted on pipelines of different diameters.

2. An automatic water extinguisher according to claim 1, wherein the extinguisher comprises one single clamping collar and only two anchoring points disposed either side of the base.

3. An automatic water extinguisher according to claim 1, wherein the anchoring points are through openings oriented in a direction parallel to the main direction of the pipeline, the elongate element being mounted on the base by inserting at least one end of the elongate element in the through openings and by forming a loop around the borders of said base.

4. An automatic water extinguisher according to claim 3, wherein the through openings are slots made in the base.

5. An automatic water extinguisher according to claim 3, wherein the through openings correspond to the space formed between the base and an axis of the base.

6. An automatic water extinguisher according to claim 2, wherein the two ends of the elongate element are configured to cooperate with the anchoring points disposed either side of the base, so that the elongate element partially surrounds the pipeline after action on the adjustment means.

7. An automatic water extinguisher according to claim 6, wherein each anchoring point comprises a housing delimited by two lugs, separated by a slot sized to enable the passage of the elongate element, the housing being configured to receive an axis fixed to an end of the elongate element, the lugs being intended configured to enable the insertion of the axes in the housings before action on the adjustment means and to block the extraction of said axes after action on the adjustment means.

8. An automatic water extinguisher according to claim 6, wherein each anchoring point comprises a lug configured to cooperate with a hole made at the ends of the elongate element.

9. An automatic water extinguisher according to claim 1, wherein the elongate element is a strip.

10. An automatic water extinguisher according to claim 1, wherein the elongate element is a cable.

11. An automatic water extinguisher according to claim 1, wherein the elongate element is formed in a metal material.

12. An automatic water extinguisher according to claim 1, wherein the adjustment means of the length of the at least one clamping collar comprise markers making it possible to compress the seal at a predetermined rate.

13. An automatic water extinguisher according to claim 1, wherein the adjustment means are integral with an end of the elongate element.

14. An automatic water extinguisher according to claim 1, wherein it further comprises an element for blocking said through-hole sensitive to temperature and configured to release the through-hole.

15. An automatic water extinguisher according to claim 1, wherein it further comprises a deflector fixed above said base and configured to spray the water flow coming from the pipeline.

16. An automatic water extinguisher according to claim 14, wherein the base and the head, comprising the deflector, the stirrups and/or the blocking element form a monolithic block.

17. An automatic water extinguisher according to claim 14, wherein the base and the head, comprising the deflector, the stirrups and/or the blocking element are independent, the head being mounted on the base by screwing.

18. Fire protection installation including:
at least one pipeline having at least one opening, and
at least one extinguisher according to claim 1.

19. Fire protection installation according to claim 18, wherein the pipeline is a pipeline painted or pre-painted on its internal and external faces.

20. Installation according to claim 19, wherein the painting of the pipeline comprises an epoxide polymer binder.
